(19) United States
(12) Patent Application Publication
(10) Pub. No.: US 2026/0159672 A1
(43) Pub. Date: Jun. 11, 2026

(54) DILATANT COMPOSITIONS

(71) Applicant: The Hong Kong Research Institute of Textiles and Apparel Limited, Hong Kong (CN)

(72) Inventors: Gloria Lei YAO, Hong Kong (CN); Erika Kit-shan NGAN, Hong Kong (CN); Hing-leung CHAN, Hong Kong (CN); Kenneth Lap-yan YEUNG, Hong Kong (CN); Harry Chun-yin CHIU, Hong Kong (CN); Skyler Shi-sum CHAN, Hong Kong (CN); Ka-hei CHAN, Hong Kong (CN); John Chi-hung CHOW, Hong Kong (CN)

(21) Appl. No.: 18/702,837

(22) PCT Filed: Feb. 17, 2023
(86) PCT No.: PCT/CN2023/076943

§ 371 Date: Apr. 19, 2024

(51) Int. Cl. C08L 1/04; C08J 9/00; C08K 3/36

(52) U.S. Cl. CPC C08L 1/04; C08J 9/008; C08K 3/36

(57) ABSTRACT

A dilatant composition including nanoparticles, a dispersion medium, optionally silicone oil, and anisotropic cellulose particles, which can act to enhance the shear thickening effect of the dilatant composition, articles including the same, and methods of preparation and use thereof. The critical shear rate of the dilatant composition can be adjusted by modifying the constituents of the dilatant composition

### TECHNICAL FIELD

The present disclosure relates to dilatant compositions articles comprising the same, and methods of use and preparation thereof.

### BACKGROUND

Dilatant composites are concentrated suspensions of particles in a urethane or a glycol medium. When these composites are stimulated with impacts, they will transition from a flexible state to a rigid state through an increase in viscosity.

D3O® and Polyanswer® have developed dilatant composites by suspending soft particles of borated silicone in urethane. These composites have been incorporated into helmets and knee pads due to their ability to absorb non-penetrating impacts effectively. Although the composites absorb over 90% of the energy from a non-penetrating impact, the composite can easily be penetrated by bullets and knives, because of the soft particles of borated silicone. Moreover, the urethane present in the composite can contain unreacted isocyanates, and these toxic compounds hinder the application of these composite in textiles.

There thus exists a need for non-toxic dilatant compositions with improved performance.

### SUMMARY

The present disclosure related to a dilatant composition comprising anisotropic cellulose particles with enhanced shear thickening effect. Anisotropic cellulose particles can fill the gap among solid particles thus enhancing the toughness of the cluster which is formed by molecular colloid. By adjusting the content of additive in the compositions to provide shear thickening effects with different critical shear rates for different applications.

In a first aspect, provided herein is a dilatant composition comprising nanoparticles, anisotropic cellulose particles, a dispersion medium, and optionally silicone oil.

In certain embodiments, the nanoparticles are selected from the group consisting of: corn starch, silicone dioxide, neodymium oxide, and combinations thereof.

In certain embodiments, the nanoparticles have an average diameter of 200-700 nm.

In certain embodiments, the anisotropic cellulose particles are cellulose nanocrystals, cellulose nanofibers, or a combination thereof.

In certain embodiments, the anisotropic cellulose particles are rod shaped.

In certain embodiments, the anisotropic cellulose particles have an average aspect ratio of 20-150 to 1.

In certain embodiments, the anisotropic cellulose particles have an average aspect ratio of 20-25 to 1.

In certain embodiments, the dispersion medium comprises an alkylene glycol, a polyalkylene glycol, a glycol ether, glycerol, or combinations thereof.

In certain embodiments, the dispersion medium comprises ethylene glycol, poly(ethylene glycol), glycerol, or combinations thereof.

In certain embodiments, the mass ratio of the anisotropic cellulose particles to the nanoparticles is from 1:500 to 1:4.

In certain embodiments, the mass ratio of the silicone oil to the dispersion medium is from 1:100 to 1:1.

In certain embodiments, the dilatant composition has a critical shear rate between 0.1 to 10 s⁻¹.

In certain embodiments, the nanoparticles have an average diameter of 300-600 nm and the anisotropic cellulose particles have an average aspect ratio of 20-25 to 1.

In certain embodiments, the nanoparticles and anisotropic cellulose particles are present in the dilatant composition at a concentration of 50-70% m/w.

In certain embodiments, the nanoparticles are silicon dioxide nanoparticles having an average diameter of 400-500 nm and the anisotropic cellulose particles are cellulose nanocrystals having an average aspect ratio of 50-100 nm to 2-5 nm.

In certain embodiments, the mass ratio of the anisotropic cellulose particles to the nanoparticles is from 1:200 to 1:4.

In a second aspect, provided herein is an article comprising the dilatant composition described herein

In certain embodiments, the method comprising combining the nanoparticles, the anisotropic cellulose particles, the dispersion medium, and optionally silicone oil thereby forming the dilatant composition.

In certain embodiments, the step of combining further comprises at least one of mixing and ultrasonication.

In certain embodiments, step of combining comprises providing the dispersion medium; adding the nanoparticles and the anisotropic cellulose particles to the dispersion medium thereby forming the dispersion mixture; mixing the dispersion mixture by using at least one of stirring and ultrasonication; and optionally adding silicone oil to the dispersion mixture and mixing the dispersion mixture by using at least one of stirring and ultrasonication thereby forming the dilatant composition.

### BRIEF DESCRIPTION OF THE DRAWINGS

The above and other objects and features of the present invention will become apparent from the following description of the invention, when taken in conjunction with the accompanying drawings, in which:

FIG. 1 depicts a graph showing the rheological performance of Examples 1 and 2.

FIG. 2 depicts a graph showing the rheological performance of Examples 3 and 4.

FIG. 3 depicts a graph showing the rheological performance of Examples 5-8.

FIG. 4 depicts a graph showing the rheological performance of Examples 9 and 10.

### DETAILED DESCRIPTION

### Definitions

Throughout the present specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the present invention.

Furthermore, throughout the present specification and claims, unless the context requires otherwise, the word “include” or variations such as “includes” or “including”, will be understood to imply the inclusion of a stated integer or group of integers but not the exclusion of any other integer or group of integers.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10%, ±7%, ±5%, ±3%, ±1%, or ±0% variation from the nominal value unless otherwise indicated or inferred.

It should be understood that the order of steps or order for performing certain actions is immaterial so long as the present teachings remain operable. Moreover, two or more steps or actions may be conducted simultaneously.

Provided herein is a dilatant composition comprising nanoparticles, anisotropic cellulose particles, a dispersion medium, and optionally silicone oil.

The choice of the nanoparticles is not particularly limited, and all types of nanoparticles are contemplated by the present disclosure. In certain embodiments, the nanoparticles are inorganic nanoparticles, polymeric nanoparticles, or a mixture thereof.

Examples of the inorganic nanoparticles used herein include, but are not limited to, silica, silicon dioxide, neodymium oxide, alumina, magnesia, zirconia, titanium oxide, zirconium oxide, zinc oxide, cerium oxide, magnesium oxide, barium sulfate, calcium sulfate, magnesium sulfate, calcium carbonate, magnesium carbonate, talc, mica, kaolin, sericite, muscovite, synthetic mica, phlogopite, lepidolite, biotite, lithia mica, silicic acid, silicic anhydride, aluminum silicate, magnesium silicate, magnesium aluminum silicate, calcium silicate, barium silicate, strontium silicate, tungstic acid metal salts, hydroxyapatite, vermiculite, haidingerite, bentonite, montmorillonite, hectorite, zeolite, ceramics powder, calcium secondary phosphate, aluminum hydroxide, boron nitride, and the like.

Exemplary polymeric nanoparticles, include, but not are limited to polystyrene, polyacrylate, polymethylmetharylate, polyvinylchloride, poly(styrene-co-acrylonitrile), polystyrene, polyvinyl acetate, polyurethane, corn starch, wheat starch, and styrene-acrylate copolymer and the like.

In certain embodiments, the nanoparticles are selected from the group consisting of corn starch, silicone dioxide, neodymium oxide, and combinations thereof.

The nanoparticles can take any shape including, but not limited to spherical, triangular, cubic, hexagonal, oval, prism, rod, conical shape, or a mixture of different shapes. In certain embodiments, the nanoparticles have an irregular shape.

The nanoparticles can have an average diameter of 100-900 nm, 100-800 nm, 100-700 nm, 100-600 nm, 200-600 nm, 250-600 nm, 300-600 nm, 300-550 nm, 350-550 nm, 350-500 nm, 400-500 nm, or 425-475 nm. In certain embodiments, the nanoparticles have an average diameter of about 450 nm.

The anisotropic cellulose particles can be cellulose nanocrystals, cellulose nanofibers, or a mixture thereof.

The anisotropic cellulose particles as used herein may be shaped, for example, as rods, flakes, tetrahedra, or laminations. In certain embodiments, the anisotropic cellulose particles are rod shaped.

The anisotropic cellulose particles can have an average aspect ratio of at least 2, at least 3, at least 4, at least 5, at least 6, at least 7, at least 8, at least 9, at least 10, at least 15, at least 20, at least 25, at least 50, at least 75, at least 100, or at least 150. In certain embodiments, the anisotropic cellulose particles have an average aspect ratio of 5-200, 5-150, 5-100, 5-50, 5-25, 10-25, 15-25, 20-25, 5-150, 20-150, or 20-200. In certain embodiments, the anisotropic cellulose particles have an average aspect ratio of about 22.35 to 1.

The average aspect ratio can be defined as the average ratio of the length of the longest dimension of the anisotropic cellulose particle to the average length of the shortest dimension of the anisotropic cellulose particle, wherein the longest dimension is substantially orthogonal (e.g., orthogonal or nearly orthogonal) to the shortest dimension.

The longest dimension of the anisotropic cellulose particles can have an average length of 50-3,000 nm, 50-2,500 nm, 50-2,000 nm, 50-1,500 nm, 50-1,000 nm, 50-500 nm, 50-400 nm, 50-300 nm, 50-200 nm, 50-100 nm, 50-90 nm, 50-80 nm, 60-80 nm, or 70-80 nm,. In certain embodiments, the longest dimension of the anisotropic cellulose particles is about 76 nm.

The shortest dimension of the anisotropic cellulose particles can have an average length of 1-30 nm, 1-25 nm, 1-20 nm, 2-20 nm, 2-15 nm, 2-10 nm, 2-10 nm, 2-9 nm, 2-8 nm, 2-7 nm, 2-6 nm, 2-5 nm, 2-4 nm, or 3-4 nm. In certain embodiments, the shortest dimension of the anisotropic cellulose particles is about 3.4 nm.

In certain embodiments, the longest dimension of the anisotropic cellulose particles has an average length of 50-3,000 nm and the, the shortest dimension of the anisotropic cellulose particles has an average length of 2-20 nm.

The dispersion medium can be an alkylene glycol, a polyalkylene glycol, a glycol ether, glycerol, polyvinyl alcohol, or combinations thereof. The average molecular weight of the alkylene glycol, a polyalkylene glycol, a glycol ether, glycerol, or polyvinyl alcohol can range from 100-30,000 amu.

In certain embodiments, the dispersion medium comprises ethylene glycol, poly(ethylene glycol), polyvinyl alcohol, glycerol, or combinations thereof. In certain embodiments, the dispersion medium comprises glycerol. The average molecular weight of the poly(ethylene glycol) can range from 100-15,000 amu and the molecular weight of the polyvinyl alcohol can range from 26,000-30,000 amu.

Advantageously, addition of silicone to the dilatant composition can modify the critical shear rate and max viscosity of the resulting dilatant composition. The silicone oil can be a polydimethylsiloxane (PDMS), a polymethyl hydrogen siloxane, an amino silicone, a phenyl methyl silicone, and the like. The average molecular weight of the silicone oil can range between 10,000-100,000 amu. In certain embodiments, the mass ratio of the silicone oil to the dispersion medium is less than 1:1, less than 2:3, less than 3:7, less than 1:4, less than 1:9, or less than 5:95, respectively.

In certain embodiments, the dilatant compositions of the present disclosure can be formed by nanoparticles, poly (ethylene glycol) or glycerin as dispersion medium, anisotropic cellulose particles and silicone oil as additive, in the dilatant composition, the weight percentage of the solid content can be 40-67%. The ratio of anisotropic cellulose particles to nanoparticles can be 0 to 1:4 and the ratio of silicone oil to dispersion medium can be 0 to 1:4.

The present disclosure also provides articles comprising the dilatant compositions described herein. The article may be a substrate, such as foams, fibers, woven and non-woven fabrics, laminates, composites and the like, and protective equipment, such as motorcycle helmets, sporting helmets, protective gloves, protective footwear, protective vests, protective kneepads, protective elbow pads, and other protective equipment. The fibers can comprise aramid, ultra-high molecular weight polyethylene, ultra-high molecular weight polypropylene, ultra-high molecular weight polyvinyl alcohol, nylon, and polyvinyl chloride, and mixtures thereof. Woven articles can comprise the aforementioned fibers.

The dilatant composition described herein can be prepared by combining and mixing the components of the dilatant composition. In certain embodiments, the dilatant composition is prepared according to a method comprising: combining the nanoparticles, the anisotropic cellulose particles, the dispersion medium, and optionally silicone oil thereby forming the dilatant composition.

The step of combining the nanoparticles, anisotropic cellulose particles, a dispersion medium, and optionally silicone oil can optionally comprise the step of mixing. Mixing can be performed in any way known to the person skilled in the art. Commonly used mixing devices are a tumbler mixer, a high-speed mixer; blenders, for example V blender, ribbon blender or a cone blender; mixers, for example a jet mixer, a planetary kneader, or a Banbury mixer.

The step of combining the nanoparticles, anisotropic cellulose particles, the dispersion medium, and optionally silicone oil can optionally comprise the step of sonicating. In certain embodiments, the nanoparticles, the anisotropic cellulose particles, and the dispersion medium are combined thereby forming a dispersion mixture; and mixing and sonicating the dispersion mixture. The steps of mixing and/or sonicating can be repeated 1, 2, 3, 4, 5, 6, 7, 8, 9, 10, or more times. In certain embodiments, the step of sonicating comprises ultrasonication.

In certain embodiments, the combining the nanoparticles, anisotropic cellulose particles, a dispersion medium are combined and optionally mixed and/or sonicated one or more times; then adding the silicone oil and optionally mixed and/or sonicated one or more times thereby forming the dilatant composition.

The nanoparticles and/or anisotropic cellulose particles can be added to dispersion medium in one portion or portion-wise. In instances in which the nanoparticles and/or anisotropic cellulose particles are added portion-wise, they can be added in 2, 3, 4, 5, 6, 7, 9, 9, 10, or more portions. Addition of the nanoparticles and/or anisotropic cellulose particles to the dispersion medium can assist with dispersing the solid components in the dispersion medium.

In certain embodiments, the dilatant composition is prepared according to a method comprising:
1. Pre-weighted nanoparticles and anisotropic cellulose particles were evenly dispersed in the dispersion medium thoroughly fully stirred to obtain a well-mixed fluid.
2. the viscosity of the mixture was reduced by probe sonication and further stirring
3. an evenly distributed fluid was produced by repeating step 2 twice.
4. Silicone oil was optionally added to the fluid, if needed.
5. The fluid was stirred then subjected to ultrasonication and stirred again.
6. Repeated step 5 twice to provide an evenly distributed composition.

The critical shear rate of the dilatant composition can be adjusted from 0.1 to 10 s⁻¹ by adjusting the content of the fluid.

### EXAMPLES

### Example 1

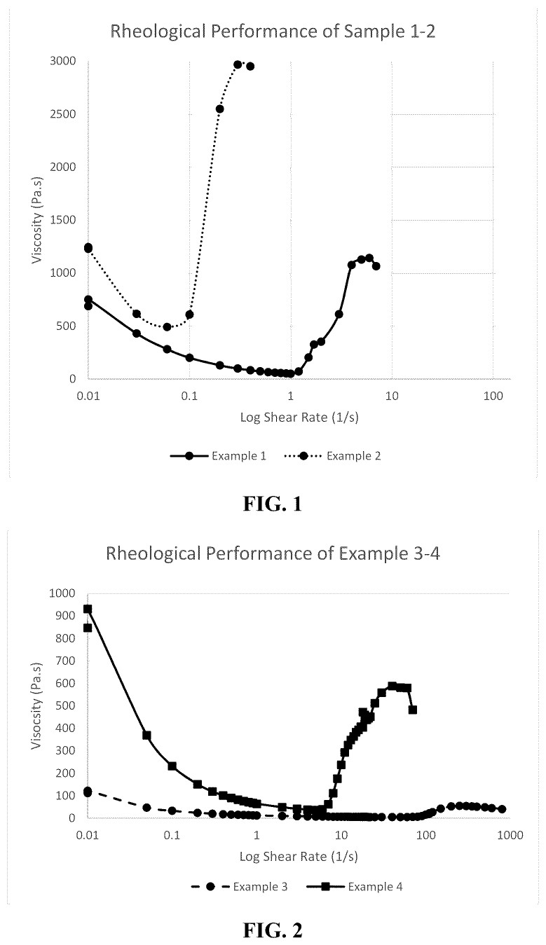

13.40 g of Silicon dioxide nanoparticle with a particle diameter of 450 nm were used as the dispersion phase, 5.28 g of polyethylene glycol with average molecular weight 400 g/mol and 1.32 g of silicone oil are used as the dispersion medium, and a ultrasonication method was adopted. The steps are as follows:
1. Pre-weighed and mixed the nanoparticles.
2. Added one third of the nanoparticles in polyethylene glycol and stirred the mixture by glass rod until evenly distributed.
3. Sonicated the fluid using 550 W sonication probe with 10% power for 3 minutes.
4. Stirred the fluid by glass rod to produce a more evenly distributed fluid.
5. Added another one third of the nanoparticles into the fluid and repeated step 2 and 3.
6. Repeated step 5.
7. Added silicone oil into the fluid and stirred the mixture by glass rod until evenly distribution.
8. Sonicated the fluid using 550 W sonication probe with 10% power by 3 minutes.
9. Stirred the fluid by glass rod to produce a more evenly distributed fluid.
   The weight of solid content percentage was 67%. The fluid was measured by the rheometer and the critical shear rate and max viscosity were 1 s⁻¹ and 1142.45 Pa⋅s (FIG. 1).

### Example 2

13.30 g of Silicon dioxide particle with a particle diameter of 450 nm and 0.10 g of cellulose nanocrystal with average aspect ratio 76 nm to 3.4 nm were used as the dispersion phase, 5.28 g of polyethylene glycol with average molecular weight 400 g/mol and 1.32 g of silicone oil were used as the dispersion medium, and a ultrasonication method was adopted for mixing. The steps are as follows:
1. Pre-weighed and mixed the nanoparticles and cellulose nanocrystals.
2. Added one third of the nanoparticles and cellulose nanocrystals in polyethylene glycol and stirred the mixture by glass rod until evenly distributed.
3. Sonicated the fluid using 550 W sonication probe with 10% power for 3 minutes.
4. Stirred the fluid by glass rod to produce a more evenly distributed fluid.
5. Added another one third of the nanoparticles and cellulose nanocrystals into the fluid and repeated step 2 and 3.
6. Repeated step 5.
7. Added silicone oil into the fluid and stirred the mixture by glass rod until evenly distribution.
8. Sonicated the fluid using 550 W sonication probe with 10% power by 3 minutes.
9. Stirred the fluid by glass rod to produce a more evenly distributed fluid.
   The weight of solid content percentage is 67%. The fluid was measured by the rheometer and the critical shear rate and max viscosity were 0.1 s⁻¹ and 2966.9 Pa⋅s (FIG. 1).

### Example 3

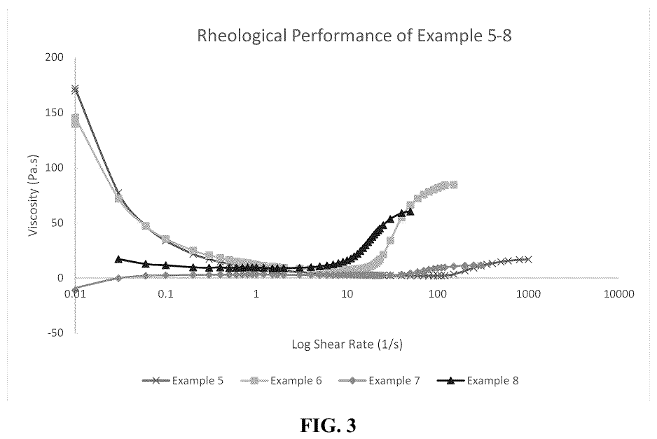

13.40 g of Silicon dioxide nanoparticle with a particle diameter of 450 nm was used as the dispersion phase, 6.60 g of glycerol were used as the dispersion medium, and a ultrasonication method was adopted. The steps are as follows:
1. Pre-weighed and mixed the nanoparticles.
2. Added one third of the nanoparticles in glycerol and stirred the mixture by glass rod until evenly distributed.
3. Sonicated the fluid using 550 W sonication probe with 10% power for 3 minutes.
4. Stirred the fluid by glass rod to produce a more evenly distributed fluid.
5. Added another one third of the nanoparticles into the fluid and repeated step 2 and 3.
6. Repeated step 5.
   The weight of solid content percentage was 67%. The fluid was measured by the rheometer and the critical shear rate and max viscosity were 100 s⁻¹ and 54.4 Pa⋅s (FIG. 2).

### Example 4

13.30 g of Silicon dioxide nanoparticle with a particle diameter of 450 nm and 0.10 g of cellulose nanocrystal with average aspect ratio 76 nm to 3.4 nm were used as the dispersion phase, 6.60 g of glycerol were used as the dispersion medium, and a ultrasonication method was adopted. The steps are as follows:
1. Made a fluid by following the preparation method of Example 3 step 1 to 6 to disperse particles into glycerol.
   The weight of solid content percentage was 67%. The fluid was measured by the rheometer and the critical shear rate and max viscosity were 7 s⁻¹ and 588.3 Pa⋅s (FIG. 2).

### Example 5

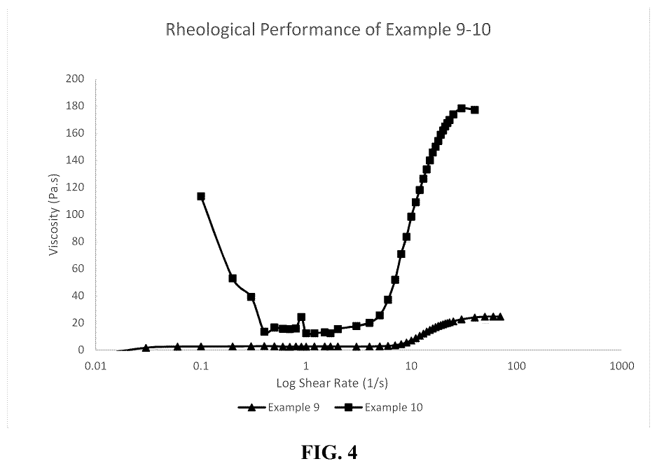

13.40 g of Silicon dioxide particle with a particle diameter of 300 nm was used as the dispersion phase, 6.60 g of polyethylene glycol with average molecular weight 200 g/mol was used as the dispersion medium, and a ultrasonication method was adopted for mixing. The steps are as follows:
1. Made a fluid by following the preparation method of Example 1 step 1 to 6 to disperse particles into polyethylene glycol.
   The weight of solid content percentage is 67%. The fluid was measured by the rheometer and the critical shear rate and max viscosity were 100 s⁻¹ and 16.7 Pa⋅s (FIG. 3).

### Example 6

13.40 g of Silicon dioxide particle with a particle diameter of 300 nm was used as the dispersion phase, 6.60 g of polyethylene glycol with average molecular weight 600 g/mol was used as the dispersion medium, and a ultrasonication method was adopted for mixing. The steps are as follows:
1. Made a fluid by following the preparation method of Example 1 step 1 to 6 to disperse particles into polyethylene glycol.
   The weight of solid content percentage is 67%. The fluid was measured by the rheometer and the critical shear rate and max viscosity were 10 s⁻¹ and 84.6 Pa⋅s (FIG. 3).

### Example 7

13.40 g of Silicon dioxide particle with a particle diameter of 600 nm was used as the dispersion phase, 6.60 g of polyethylene glycol with average molecular weight 200 g/mol was used as the dispersion medium, and a ultrasonication method was adopted for mixing. The steps are as follows:
1. Made a fluid by following the preparation method of Example 1 step 1 to 6 to disperse particles into polyethylene glycol.
   The weight of solid content percentage is 67%. The fluid was measured by the rheometer and the critical shear rate and max viscosity were 100 s⁻¹ and 11.4 Pa⋅s (FIG. 3).

### Example 8

13.40 g of Silicon dioxide particle with a particle diameter of 600 nm was used as the dispersion phase, 6.60 g of polyethylene glycol with average molecular weight 600 g/mol was used as the dispersion medium, and a ultrasonication method was adopted for mixing. The steps are as follows:
1. Made a fluid by following the preparation method of Example 1 step 1 to 6 to disperse particles into polyethylene glycol.
   The weight of solid content percentage is 67%. The fluid was measured by the rheometer and the critical shear rate and max viscosity were 10 s⁻¹ and 60.1 Pa⋅s (FIG. 3).

Example 9

13.40 g of Silicon dioxide nanoparticle with a particle diameter of 450 nm was used as the dispersion phase, 6.60 g of polyethylene glycol with molecular weight 400 is used as the dispersion medium, and a ball mill method was adopted. The steps are as follows:
1. Pre-weighed the nanoparticles and polyethylene glycol.
2. Added grinders, polyethylene glycol and half of the nanoparticles into a grinding jar and ball mill the mixture for 3 hours.
3. Added the remaining half of the nanoparticles into the grinding jar and ball mill the mixture for another 3 hours.
   The weight of solid content percentage was 67%. The fluid was measured by the rheometer and the critical shear rate and max viscosity were 5 s⁻¹ and 26.74 Pa⋅s (FIG. 4).

### Example 10

13.30 g of Silicon dioxide nanoparticle with a particle diameter of 450 nm and 0.10 g of cellulose nanocrystal with average aspect ratio 100 μm to 10 μm were used as the dispersion phase, 6.60 g of polyethylene glycol with molecular weight 400 is used as the dispersion medium, and a ball mill method was adopted. The steps are as follows:
1. Pre-weighed the nanoparticles, anisotropic particles and polyethylene glycol.
2. Added grinders, polyethylene glycol, half of the nanoparticles and half of the anisotropic particles into a grinding jar and ball mill the mixture for 3 hours.
3. Added the remaining half of the nanoparticles and half of the anisotropic particles into the grinding jar and ball mill the mixture for another 3 hours.
   The weight of solid content percentage was 67%. The fluid was measured by the rheometer and the critical shear rate and max viscosity were 5 s⁻¹ and 179.69 Pa⋅s (FIG. 4).

What is claimed is:

1. A dilatant composition comprising nanoparticles, anisotropic cellulose particles, a dispersion medium, and optionally silicone oil.

2. The dilatant composition of claim 1, wherein the nanoparticles are selected from the group consisting of: corn starch, silicone dioxide, neodymium oxide, and combinations thereof.

3. The dilatant composition of claim 1, wherein the nanoparticles have an average diameter of 200-700 nm.

4. The dilatant composition of claim 1, wherein the anisotropic cellulose particles are cellulose nanocrystals, cellulose nanofibers, or a combination thereof.

5. The dilatant composition of claim 1, wherein the anisotropic cellulose particles are rod shaped.

6. The dilatant composition of claim 5, the anisotropic cellulose particles have an average aspect ratio of 20-150 to 1.

7. The dilatant composition of claim 5, the anisotropic cellulose particles have an average aspect ratio of 20-25 to 1.

8. The dilatant composition of claim 1, wherein the dispersion medium comprises an alkylene glycol, a polyalkylene glycol, a glycol ether, glycerol, or combinations thereof.

9. The dilatant composition of claim 1, wherein the dispersion medium comprises ethylene glycol, poly(ethylene glycol), glycerol, or combinations thereof.

10. The dilatant composition of claim 1, wherein the mass ratio of the anisotropic cellulose particles to the nanoparticles is from 1:500 to 1:4.

11. The dilatant composition of claim 1, wherein the mass ratio of the silicone oil to the dispersion medium is from 1:100 to 1:1.

12. The dilatant composition of claim 1, wherein the dilatant composition has a critical shear rate between 0.1 to 10 s⁻¹.

13. The dilatant composition of claim 1, wherein the nanoparticles have an average diameter of 300-600 nm and the anisotropic cellulose particles have an average aspect ratio of 20-25 to 1.

14. The dilatant composition of claim 1, wherein the nanoparticles and anisotropic cellulose particles are present in the dilatant composition at a concentration of 50-70% m/w.

15. The dilatant composition of claim 14, wherein the nanoparticles are silicon dioxide nanoparticles having an average diameter of 400-500 nm and the anisotropic cellulose particles are cellulose nanocrystals having an average aspect ratio of 50-100 nm to 2-5 nm.

16. The dilatant composition of claim 15, wherein the mass ratio of the anisotropic cellulose particles to the nanoparticles is from 1:200 to 1:4.

17. An article comprising the dilatant composition of claim 1.

18. A method of preparing the dilatant composition of claim 1, the method comprising combining the nanoparticles, the anisotropic cellulose particles, the dispersion medium, and optionally silicone oil thereby forming the dilatant composition.

19. The method of claim 18, wherein the step of combining further comprises at least one of mixing and ultrasonication.

20. The method of claim 18, wherein the step of combining comprises providing the dispersion medium; adding the nanoparticles and the anisotropic cellulose particles to the dispersion medium thereby forming the dispersion mixture; mixing the dispersion mixture by using at least one of stirring and ultrasonication; and optionally adding silicone oil to the dispersion mixture and mixing the dispersion mixture by using at least one of stirring and ultrasonication thereby forming the dilatant composition.
